(19) United States
(12) Patent Application Publication
(10) Pub. No.: US 2017/0210525 A1
(43) Pub. Date: Jul. 27, 2017

(54) GIFT ASSEMBLIES

(71) Applicant: American Greetings Corporation, Cleveland, OH (US)

(72) Inventors: David Mayer, Bay Village, OH (US); Allison Marsh, Olmsted Township, OH (US); Carol Miller, Twinsburg, OH (US); Gary Nelson, Avon, OH (US)

(21) Appl. No.: 15/417,074

(22) Filed: Jan. 26, 2017

Related U.S. Application Data
(60) Provisional application No. 62/287,206, filed on Jan. 26, 2016.
(60) Provisional application No. 62/400,866, filed on Sep. 28, 2016.
(60) Provisional application No. 62/403,600, filed on Oct. 3, 2016.

(51) Int. Cl. B65D 51/26; G06Q 20/18; B65D 43/14; B65D 25/10; B65D 25/54

(52) U.S. Cl. CPC B65D 51/26; B65D 25/10; B65D 25/54; B65D 43/14; G06Q 20/18

(57) ABSTRACT

A token provides the recipient with access to gifted content. Upon activation and redemption of the token, the recipient may be gain access to a gift, and the gift can take various forms. Some gifts may be electronic, while others may be physical in nature. Physical gifts, such as subscription-based gifts are not physically present at the time of giving. The token is pre-packaged in a fun gift packaging, making the gifting and unwrapping experience more meaningful.

### CROSS-REFERENCE TO RELATED APPLICATIONS

The present application is a non-provisional of U.S. Provisional Patent Application No. 62/287,206, filed Jan. 26, 2016, U.S. Provisional Patent Application No. 62/400,866, filed Sep. 28, 2016, and U.S. Provisional Patent Application No. 62/403,600, filed Oct. 3, 2016. The entire disclosures of the above applications are incorporated herein by reference.

### BACKGROUND

The present disclosure is in the field of social expression products, and more specifically to gift assemblies (e.g., a token and corresponding packaging) useful in providing access to an electronic or physical gift item.

The process of gifting a recipient a gift subscription or membership to a digital or physical good or service via the internet has long been accomplished by providing the gift recipient with a printed piece of paper which provides the subscription or gift information which the recipient can then use to redeem or otherwise access gifted content or a photo of a gift which is to be delivered at a later date. Later, emails or text messages were used to notify a recipient of this type of gift and provide the recipient with a link to the gifted content or other information required to redeem said gift. These methods are boring and impersonal and lack the surprise and entertainment value of receiving and unwrapping an actual physical gift. There is a long felt need to provide a more meaningful way to gift virtual, electronic or physical gift items that are not physically present or on-hand during the gift presentation process.

### SUMMARY

The gift assemblies, kiosks, bundled gifts, and/or other embodiments of the present disclosure provide a unique, fun and more personal way to gift virtual, digital or later-arriving physical gift items to a recipient. The tokens described herein are a representation of the actual gift and also provide information required to unlock, redeem or otherwise provide access to the gifted product or content. The tokens may be packaged in a fun, entertaining way which greatly improves the unwrapping process and provides a meaningful gift giving and receiving experience.

In an example embodiment of the present disclosure, a gift assembly includes packaging and a token. In such embodiments, the packaging includes a base having a top surface and a bottom surface opposite the top surface. The packaging also includes a lid moveable relative to the base between a first position in which a bottom surface of the lid extends substantially parallel to the top surface of the base, and a second position in which the bottom surface of the lid extends at an included angle relative to the top surface of the base. The packaging also includes a pop-up structure disposed between the top surface of the base and the bottom surface of the lid. The pop-up structure may be configured such that movement of the lid causes commensurate movement of the pop-up structure. Additionally, the token of such a gift assembly may be removably retained by the pop-up structure. At least one of the token or the packaging includes a unique identifier operative to provide access to a digital gift.

In another example embodiment of the present disclosure, a gift assembly includes packaging, a token, and an additional gift item that is physically separate from the token. In such examples, the packaging includes a base having a top surface and a bottom surface opposite the top surface, and a lid moveable relative to the base to provide access to an inner compartment of the packaging. The packaging also includes a first retention component disposed within the inner compartment, and a second retention component separate from the first retention component disposed within the inner compartment. In such examples, the token may be removably retained by the first retention component within the inner compartment. At least one of the token or the packaging may include a unique identifier operative to provide access to a digital gift associated with the token. Further, the additional gift item may be associated with a theme corresponding to the token, and may be removably retained by the second retention component within the inner compartment.

In still another example embodiment of the present disclosure, a kiosk includes one or more walls, a controller at least partially supported by the one or more walls and operably connected to a network, and a display connected to the controller and configured to assist a user in generating a token. In such example embodiments the token may include a unique identifier operative to provide access to a digital gift. Additionally, the controller may be configured to enable the user to, using the network, at least one of purchase and activate the token at the kiosk.

### BRIEF DESCRIPTION OF THE DRAWINGS

This detailed description makes reference to the accompanying figures. In the figures, the left-most digit(s) of a reference number identifies the figure in which the reference number first appears. The same reference numbers in different figures indicate similar or identical items.

FIG. 1 is a front view of a token within gift packaging.

FIG. 2 is a rear view of the gift packaging of FIG. 1.

FIG. 3 is a perspective view of an example gift assembly of the present disclosure.

FIG. 4 is a perspective view of an example kiosk of the present disclosure.

FIG. 5 illustrates various user interfaces associated with a mobile app for redeeming tokens.

FIG. 6 is a flowchart illustrating an example method of the present disclosure.

FIG. 7 illustrates an example gift bundle of the present disclosure.

FIG. 8 illustrates another example gift bundle of the present disclosure.

### DETAILED DESCRIPTION

### Form Factor

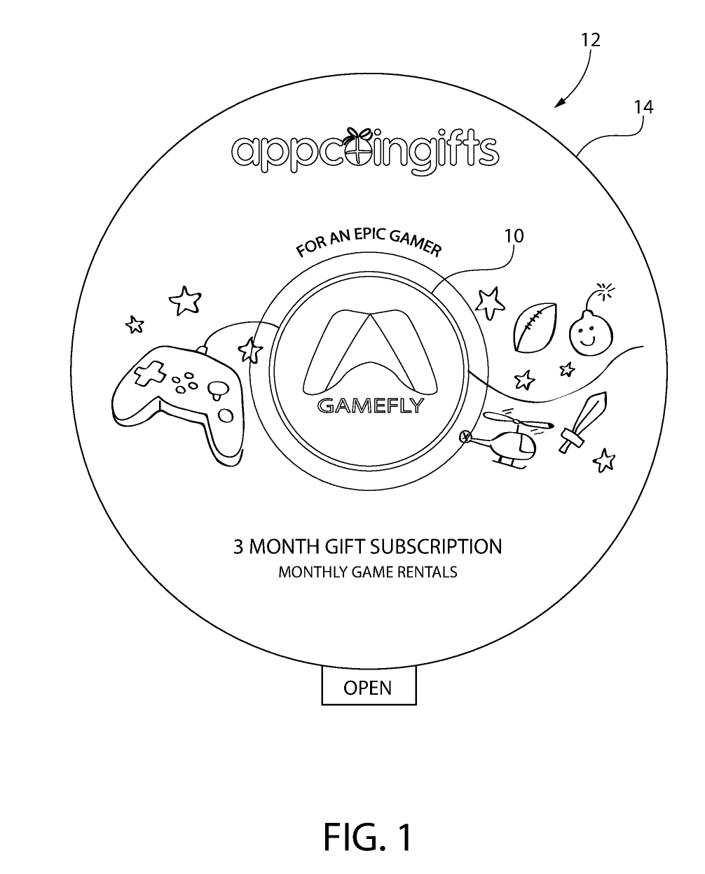

As shown in FIG. 1, an example embodiment of the present disclosure is directed to a gift assembly including a token 10 and/or associated gift packaging 12. In example embodiments, a token 10 of the present disclosure may be used to unlock, redeem or otherwise provide access to an electronic, a virtual or physical gift item. Alternatively, the token 10 may be used as a physical carrier of an electronic or virtual gift item or content. As used herein the term “token” refers to a physical item such as a coin, a figurine, game piece, a chip, a badge, a ring, a fob, a key, or the like. The token 10 may be shaped like a circle, a square, a triangle, or any other conceivable shape, or it may take the form of a figurine, such as a character or doll, or it may be shaped like a game piece, such as those used in board games. The token 10 may be made of paper, foam, metal, plastic, cardboard, paperboard, chipboard, fiberboard, wood, or any other conceivable material or a combination thereof. The token 10 may contain printing thereon which includes but is not limited to: a picture, a drawing, a photograph, a logo, printed text, instructions for redeeming the token, and a code for redeeming or unlocking the token 10. In an example embodiment, the token 10 is a circular-shaped coin which contains a code printed thereon for unlocking or otherwise providing access to an electronic, virtual or physical gift. As will be described in greater detail below, any of the tokens 10 described herein may have a top surface, a bottom surface opposite the top surface, and a unique identifier disposed on one of the top surface and the bottom surface. The unique identifier (e.g., a unique code or other indicia) may be operative to provide access to a digital gift separate from the token 10. Additionally, any of the tokens 10 described herein may include visual indicia disposed on at least one of the top surface and the bottom surface, and the visual indicia may be indicative of the digital gift.

The token 10 provides an alternate avenue for the presentation of a gift that is not otherwise “in-hand” at the time of gifting. For example, in order to gift someone a subscription to a subscription based service, consumers or the subscription service may send the gift recipient an email or text message informing the recipient of the gift. Alternately, the consumer must print out a sheet of paper with the subscription information printed thereon and present that to the recipient at the time of gifting. This method of gifting lacks sentiment and the entertainment value of receiving a gift. It gives the perception that the email or printed paper is an IOU instead of an actual gift. Gifting the token 10 of the present disclosure, on the other hand, provides the consumer with a fun, unique and physical way to gift such items to a recipient.

In an example embodiment, the token 10 may be pre-packaged at least partially within and/or may otherwise be at least temporarily retained by gift packaging 12 which gives the gift recipient a feeling of actually receiving a physical gift even though the actual gift item (such as a gift subscription) is not physically present at the time of gifting. The token 10 packaged within the gift packaging 12 provides for a far more fun and entertaining gift presentation than a simple printed sheet of paper, greeting card or electronic message. As used herein the term “gift packaging” is intended to include items such as a gift box, a pop-up gift box, a three-dimensional gift presentation box, a gift bag, a gift pouch or other container typically used for gifting physical gifts. As used herein, the term “gift packaging” is not intended to include greeting cards.

### Token Content

In a preferred embodiment, the token 10 is operative to unlock, redeem or otherwise provide access to of one or more of the many gift subscription services or memberships which deliver virtual, electronic or physical goods on a recurring basis (e.g., monthly, quarterly, annually) such as magazine or newspaper subscriptions (e.g., People, Sports Illustrated, Time, Vogue, The New York Times, The Wall Street Journal), makeup or lifestyle subscriptions (e.g., BirchBox, Pop Sugar, Barkbox, Fitbox), a food subscription (e.g., Graze, HelloFresh, various food/drink of the month clubs including, but not limited to: beer, wine, tea, coffee, fruit, candy, etc.), a novelty/gaming item subscription (e.g., Gamefly, LootCrate, Nerd Block), a clothing subscription (e.g., Stitchbox, Bombfell), or any other subscription-based service. These subscriptions ultimately provide the gift recipient with physical goods, however, at the time of gifting or notification of the gift, the gift giver does not typically have any meaningful way to present the later-to-arrive gift to the recipient. The token 10, which represents the gift subscription and which provides access to the recipient for redeeming the subscription, provides a fun and entertaining way to give the recipient a physical object (e.g., the token 10) which can be unwrapped to reveal a later arriving physical gift via the subscription. In a preferred embodiment, the token 10 contains a unique code which is the key to unlocking or redeeming the gift subscription. Methods for unlocking or redeeming are discussed in further detail below.

In another embodiment, the token 10 may be operative to unlock, redeem or otherwise provide access to one or more electronic items including, but not limited to: a game; a movie; a movie clip; a video; an animated greeting; a personalized greeting; a digital book; a digital magazine; a digital magazine subscription; an audio file or audio clip; a ringtone; a music file; or a gift card. There are multiple ways in which such virtual or electronic content may be unlocked and/or redeemed. As mentioned above with respect to the gift subscription, the token 10 may contain a unique code printed thereon which is the key to unlocking or redeeming content. Other unlocking or redemption methods, which are discussed in further detail below, may include content which is embedded within or printed on the token 10.

In another embodiment, the token 10 may be operative to unlock, redeem or otherwise provide access to one or more virtual gift items or content. “Virtual gift items” are non-physical objects and/or currency for use in online communities and social media or online games. For example, characters or avatars in virtual worlds can own things within the virtual world. Virtual currency may be used to purchase items within a virtual world, such as, for example, land, supplies, weapons, and clothing, to name a few. These virtual gift items are typically available as in-app purchases (extra content and subscriptions that you can buy within an app on a mobile device or computer).

In another embodiment, the token 10 is operative to unlock, redeem or otherwise provide access to augmented reality (AR) or virtual reality (VR) environments.

In another embodiment, the token 10 is operative to unlock, redeem or otherwise provide access to one or more physical gifts or items such as a book, a game, jewelry, clothing, shoes, or any other physically gifted item.

In another embodiment, the token 10 is operative to unlock, redeem or otherwise provide access to one or more services or experiences, such as spa services, beauty services, concerts, sporting events, etc.

In another embodiment, the token 10 is operative to unlock, redeem or otherwise provide access to the token recipient's choice of gift from a specified or unspecified retailer, the coin recipient's choice of one of a pre-selected group of gift items from a specified or unspecified retailer, or the coin recipient's choice of one of a pre-selected group of gift items from one of a group of specified retailers.

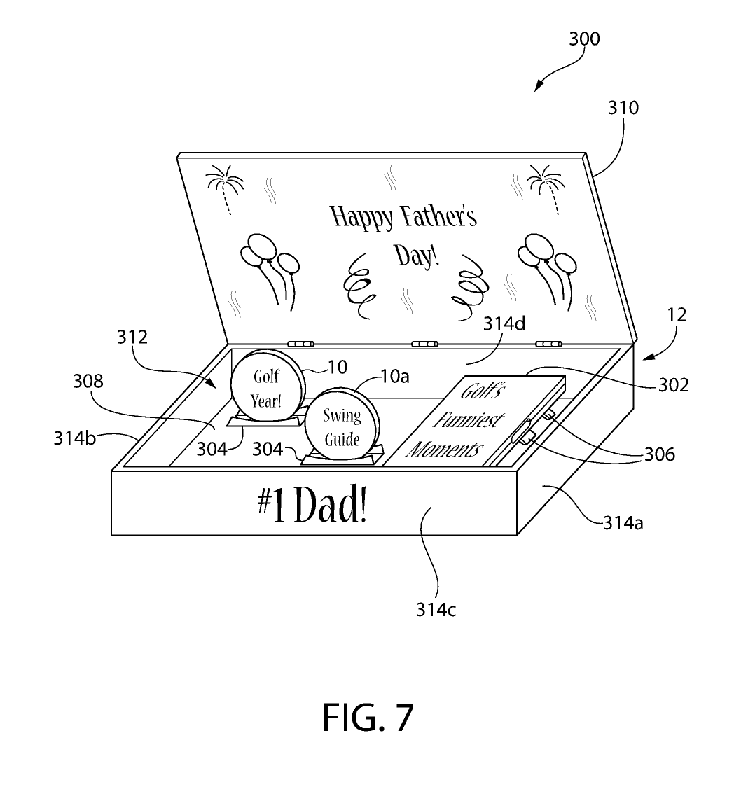

In any of the example embodiments described herein, the tokens 10, packaging 12, and/or the gift assemblies generally, may be available as “themed” gifts or gift assemblies which may contain content related to a particular theme, such as, for example, 40 Starbucks lattes for a 40th birthday, a 16-month subscription to Gamefly for a 16th Birthday, a 25-month wine subscription from Winc for a 25th wedding anniversary, a digital content subscription (e.g., Spotify, Apple Music, Netflix, HBO, etc.), or a subscription to Evernote or Lumosity for a particular work anniversary. Similarly, example tokens 10, packaging 12, and/or the gift assemblies generally, can be bundled together with one or more additional gifts to provide a multi-part gift/gift assembly. An example gift bundle 300 is illustrated in FIG. 7. In such “bundled” gift examples, one or more of the tokens 10 may provide access to respective gifts which may or may not be related to a themed event. For example, a Father's Day themed gift bundle 300 may contain 1) a first token 10 configured to enable the recipient to redeem a subscription to a golf magazine, 2) a golf-themed DVD or movie 302, and 3) a second token 10a configured to enable the recipient to download an app that provides swing analysis, course views or a handicap calculator. Such an example Father's Day themed gift bundle 300 may also include packaging 12 that includes illustrations, songs, and/or other content that is related to Father's Day. In another embodiment, an example Father's Day themed gift bundle may include 1) a token 10 configured to enable the recipient to redeem a subscription to a golf magazine, 2) a new golf club (e.g., a putter), and 3) packaging 12 that includes illustrations related to Father's Day. In any of the example themed or non-themed gift bundles 300 described herein, the gift bundle 300 may include both a token 10 and an additional gift item 302 physically separate from the token 10. In this way, the recipient of a gift bundle 300 may receive at least one physical gift item 302, in real-time, upon receipt of the gift bundle 300 (e.g., the golf-themed DVD or the new golf club in the examples described above). Upon receipt of the gift bundle 300, the recipient may also receive at least one token 10 that is operative to unlock, redeem or otherwise provide access to any of the virtual gift items, physical gifts, services, experiences, subscriptions, memberships, or other items described herein. Thus, an example gift bundle 300 may provide the recipient with the instant, real-time satisfaction of receiving an actual physical gift 302, as well as the excitement and anticipation associated with receiving a future gift item associated with the token 10.

Two or more gifts may also be bundled in a non-themed way which is specific to a gift recipient's interests or hobbies. For example, a consumer may want to curate a personalized gift bundle 300 for a gift recipient who is a foodie or has a strong interest in food and beverages. In this case the consumer may select a cook book (either digital or physical), a subscription to a food and/or wine magazine (either digital or physical), and a monthly wine or food delivery subscription. Gifts can be combined onto a single token 10 or may be bundled as separate tokens 10. For example, a single token 10 may be operative to unlock, redeem or otherwise provide access to multiple gifts or, alternatively, multiple tokens 10 may be included in the gift bundle and each of the tokens 10 may be operative to unlock, redeem or otherwise provide access to a respective gift. The gift bundles 300 may be selected from any of the categories described above and may include two, three, four, five, greater than five or however many gifts the consumer wishes to gift to the recipient. The gift bundles 300 may include digital gifts, physical gifts, virtual gifts, subscription gifts or any combination thereof. The gift bundles 300 provide the consumer with a way to provide a total gift “experience” to the gift recipient. Receiving and unwrapping a token 10 and then following the steps to redeem or perhaps reveal the gifts contained in the gift bundle provide an added level of surprise and excitement around the gift receiving experience.

Additionally, any of the packaging 12 described herein may be used with and/or included in the gift bundles of the present disclosure. In such examples, the packaging 12 may include a first retention component 304 (e.g., any of the pop-up structures or other like structures described herein configured to temporarily retain the token 10). The packaging 12 may also include a second retention component 306 separate from the first component 304 and configured to temporarily retain one or more additional gifts 302 of the gift bundle 300. Such second retention components 306 may include, for example, among other things, one or more clips, ties, latches, clamps, and/or other structures configured to retain the additional gift 302 contained within the gift bundle 300 and/or substantially within the packaging 12. In such examples, the token(s) 10 and the additional gift(s) 302 of the gift bundle 300 may be disposed substantially within, substantially enclosed by, and/or substantially surrounded by the packaging 12. For example, the packaging 12 may include a base 308, a lid 310 moveable relative to the base 308, and at least one inner compartment 312 that is accessible by moving the lid 310 relative to the base 308. Example bases, lids, and/or other components of the packaging 12 will be described in greater detail below. In some examples, the packaging 12 may also include one or more sidewalls 314a, 314b, 314c, 314d (collectively referred to herein as “sidewalls 314”) surround and forming at least a portion of the inner compartment 312. For example, an inner compartment 312 of the packaging 12 may be formed by a substantially cylindrical and/or otherwise substantially continuous sidewall. In other embodiments, on the other hand, two or more opposing sidewalls 314 may form at least part of the inner compartment 312. It is understood that the lid 310 and/or the base 308 of the packaging 12 may also form at least part of the inner compartment 312. Any of the sidewalls 314 of the packaging 12 described herein may extend substantially perpendicularly from the base 308 and/or the lid 310 of the packaging 12. In such examples, the first and second retention components 304, 306 may be disposed within the inner compartment 312 of the packaging 12. Likewise, the first and second retention components 304, 306 may temporarily retain the token(s) 10 and/or the additional gift(s) 302 of the gift bundle 300 within the inner compartment 312. For example, the first and second retention components 304, 306 may be connected to at least one of the lid 310, the base 308, and/or one or more sidewalls 314 of the packaging 12 within the inner compartment 312.

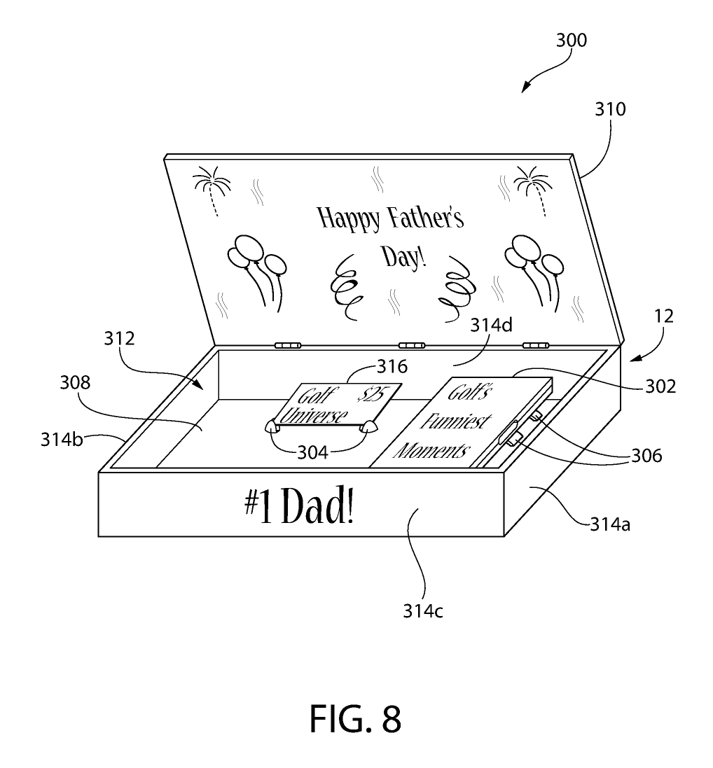

Further, in any of the gift bundle examples described herein, at least one of the token 10 and the additional gift item 302 may be a gift card having a component storing an amount of monetary value. For example, at least one of the token 10 and the additional gift item 302 may include a magnetic strip, an RFID chip, and/or other component on which any desired monetary value may be loaded before the gift bundle is given to the recipient. Such a monetary value (e.g., $25, $50, or any other dollar value) may be loaded onto the component of the gift card prior to purchasing the gift bundle 300, at the point of sale, or after the purchase of the gift bundle 300. Alternatively, as shown in FIG. 8, an example gift bundle 300 may include a gift card 316 and an additional gift item 302 separate from the gift card 316. In such examples, one or more of the tokens 10, 10a described above may be omitted from the gift bundle 300 if desired. Additionally, in such examples, the gift card 316 may include a magnetic strip, an RFID chip, and/or other component on which any desired monetary value may be loaded.

In addition to unlocking, redeeming or otherwise providing access to virtual, digital or physical content, the gift presentation process may further be extended to include an electronic greeting. When the token 10 is used by the recipient to unlock, redeem or otherwise provide access to the gifted content, an electronic message may be played for the recipient prior to receiving the gifted content. The electronic message may be in the form of an electronic greeting card which contains a message for the recipient. The message may, in some embodiments, be personalized by the gift giver prior to gifting the token to the recipient. For example, in the embodiments where the token 10 is blank and the purchaser must select content to place onto the token 10 (via a kiosk, at the point of sale, or via mobile phone or other mobile device), a process may be in place for the consumer to personalize a message to the recipient. The consumer may select from a variety of electronic greeting cards and may personalize said greeting with text, audio, video, photos and any other consumer-provided information which can be uploaded by the consumer. In other embodiments, upon redemption of the token 10 by, for example, entering a redemption code or password, a standard message or video or digital greeting may appear, such as, for example, “Happy Birthday”, “Merry Christmas” or other such sentiment. In this case, the tokens 10, as packaged at retail would need to be labeled or otherwise indicated that they are pre-loaded with a standard message for a particular occasion (e.g., Birthday, Christmas).

### Gift Packaging

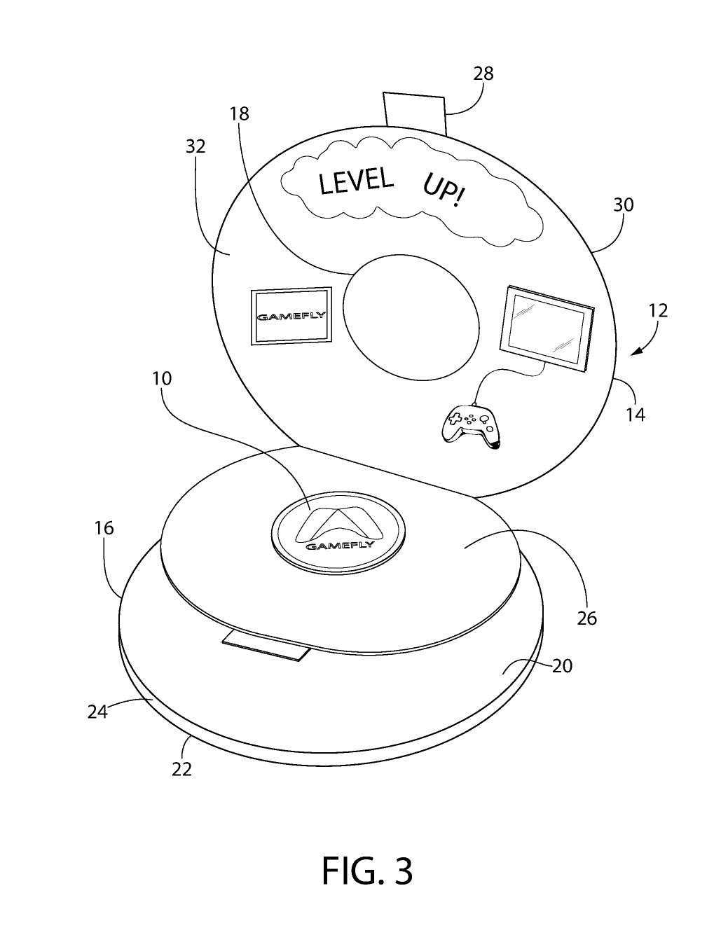

As noted above, in an example embodiment the token 10, whether purchased online or in a physical retail environment, may be packaged within gift packaging 12. In such examples, a gift assembly of the present disclosure may include, among other things, a token 10, associated packaging 12, and/or one or more components of the token 10 and the packaging 12. As can be seen in the example gift assembly shown in FIG. 3, example packaging 12 may comprise a platform, envelope, disc, box, container, or other such structure configured to at least temporarily retain one or more tokens 10. Example packaging 12 may include, for example, a cover or lid 14 that is moveable relative to and/or detachable from a base 16. For example, the packaging 12 may include a hinge, a fold, an additional flap of material, and/or other structure movably connecting the lid 14 and the base 16. In some examples, the lid 14 may include an opening 18 through which the token 10 may be visible. In such examples, the opening 18 may be covered by one or more substantially transparent layers of material to protect the token 10 during storage and/or transport. Such a layer of material may also assist in retaining the token 10 within the packaging 12 while the lid 14 is substantially closed. Additionally, the opening 18 may be disposed substantially centrally on the lid 14 (e.g., proximate an approximate center of the lid 14).

The base 16 of the packaging 12 may be made of foam, plastic, cardboard, cardstock, paper, or other lightweight material, which may have one or more cavities contained therein. In some examples, the base 16 may contain a top surface 20, a bottom surface 22 opposite the top surface 20, and a sidewall 24 spacing the top surface 20 from the bottom surface 22. The top and bottom surfaces 20, 22 of the base 16 may be at least partially covered by one or more sheets of material. The sheets of material may be paper, paperboard, cardboard, or any other printable material. In such examples, at least part of the material which is attached to the top surface 20 of the base 16 may also be partially attached to the lid 14. In such examples, the material that is attached to both the lid 14 and the base 16 may assist in connecting the lid 14 with the base 16. In any of the examples described herein, the lid 14 may be made from any of the materials described above with respect to the base 16, and the lid 14 may have a shape, diameter, thickness, size, and/or any other configuration that is substantially similar to and/or the same as the base 16.

In some examples, the packaging 12 of the gift assembly may include a three-dimensional pop-up structure 26. As shown in FIG. 3, the pop-up structure 26 may be located between the top surface 20 of the base 16 and, for example, a bottom surface 32 of the lid 14. The pop-up structure 26 may be configured to at least partially retain a token 10 of the gift assembly and, in some examples, the pop-up structure 26 may include a shelf, recess, channel, cavity, and/or other structure within with at least part of the token 10 may be disposed while the lid is substantially closed. Additionally or alternatively, the pop-up structure 26 may include an adhesive, a clip, a latch, Velcro®, and or other component to assist in temporarily retaining the token 10. In example embodiments, the lid 14 may be rotatable, pivotable, and/or otherwise moveable relative to the base 16 between a first position (e.g., substantially closed) in which the bottom surface 32 of the lid 14 extends substantially parallel to the top surface 20 of the base 16, and a second position (e.g., substantially open) in which the bottom surface 32 of the lid 14 extends at any desired included angle (e.g., an included angle between approximately 1 degree and approximately 180 degrees) relative to the top surface 20 of the base 16. In such examples, the pop-up structure 26 may be configured such that movement of the lid 14 causes commensurate movement of the pop-up structure 26. For example, the pop-up structure 26 may be at least partially connected to at least one of the lid 14 and the base 16, such that movement of the lid 14 between the first and second positions causes movement of the pop-up structure. Additionally, it is understood that when the lid 14 is in the first position described above, at least part of the pop-up structure 26 may lie flat between the top surface 20 of the base 16 and the bottom surface 32 of the lid 14. In such examples, a substantially planar surface of the pop-up structure 26 may extend substantially parallel to, may be disposed adjacent, may extend along, and/or may contact at least part of the top surface 20 of the base 16 or the bottom surface 32 of the lid 14. Further, when the lid 14 is transitioned from the first position to the second position, such movement of the lid 14 may cause the substantially planar surface of the pop-up structure 26 to be spaced from at least the top surface 20 of the base 16. For example, when the lid 14 is disposed in the second position, the substantially planar surface of the pop-up structure 26 may extend substantially parallel to the top surface 20 of the base 16. In such examples, the substantially planar portion of the pop-up structure 26 may comprise a top surface or a bottom surface of the pop-up structure.

The lid 14 may also include a tab 28 and/or other like extension attached to a surface thereof, such as a top surface 30 of the lid 14 or the bottom surface 32. In such examples, the tab 28 may be configured such that it can be grasped by a user, such as, for example, between a thumb and forefinger, and lifted to reveal the pop-up structure 26. As mentioned above, the lid 14 may include an opening 18 at the approximate center thereof through which the token 10 may be visible.

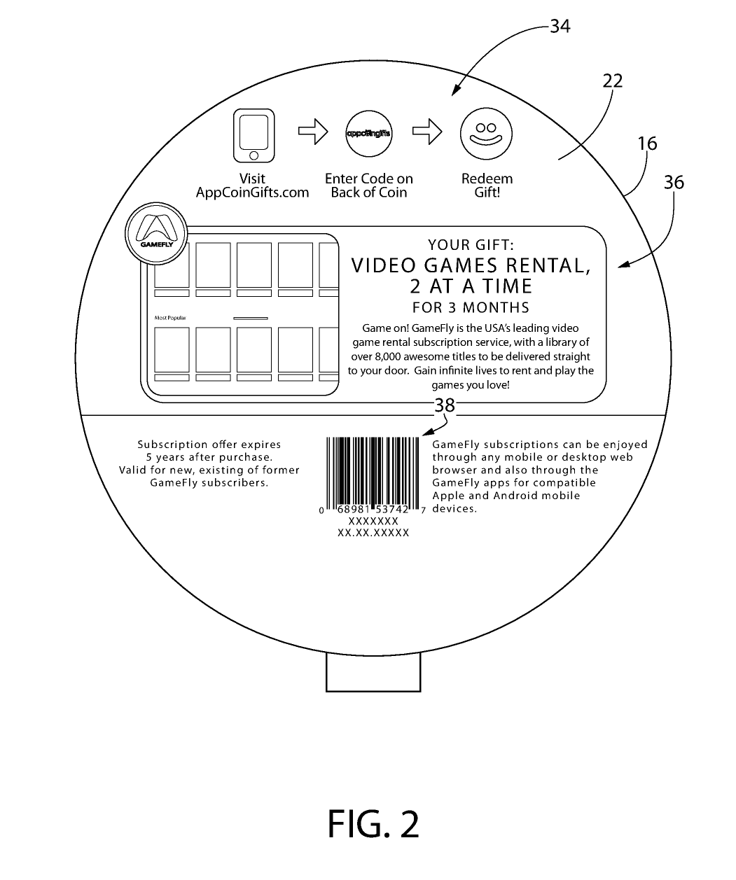

Additionally, the top surface 30 and/or the bottom surface 32 of the lid 14 may include printing thereon, such as a product logo which identifies the source of a gift associated with the token 10. The base 16 and/or the pop-up structure 26 may additionally contain printing thereon (in words and/or pictures) which illustrates what the token 10 “unlocks”. As illustrated by the example bottom surface 22 of the base 16 shown in FIG. 2, it is understood that one or more portions of the packaging 12 may also include redemption instructions 34 and may contain a gift message, information 36 related to the gift corresponding to the token 10, and/or other information (e.g., redemption codes, bar codes, etc.) 38 as well. The base 16 may also include one or more tabs which can be grasped, for example between a user's thumb and forefinger and lifted to assist in opening and/or otherwise revealing the inside of the packaging 12. In such examples, the tabs of the base 16 and of the lid 14 may be grasped by the user and separated (e.g., moved away from each other) in order to transition the packaging between a closed position in which the base 16 is disposed substantially parallel to the lid 14, and a substantially open position at which the base 16 is disposed at an included angle of between approximately 1 degree and approximately 180 degrees relative to the lid 14. Additionally, it is understood that in an additional embodiment, one or more components of the packaging 12 described herein may be modified and/or omitted in order to reduce the overall cost of manufacturing the packaging and/or to simplify the process of manufacturing the packaging 12 and/or the gift assembly. For example, in such embodiments, the opening 18 and/or the material covering the opening 18 may be omitted. Additionally or alternatively, in such examples one or more of the lid 14, the base 16, and the pop-up structure 26 may be omitted from the gift assembly.

In any of the examples described herein, the packaging 12 may also contain a sound module contained within, for example, one or more cavities of the base 16. The sound module (not shown) may be operative to store and playback at least one audio file. The sound module may contain a printed circuit board, an integrated circuit, a memory device having at least one audio file stored thereon, a speaker, a power source, related wiring and circuitry and/or any other component configured to facilitate the storage and/or emission of at least one audio file. In some examples, transitioning the packaging from the closed position to the substantially open position may activate the sound module such that the at least one audio file is played through a speaker during the opening or unwrapping experience. In some examples, each different token 10 may correspond to a unique audio clip stored within and/or otherwise playable by the sound module.

With continued reference to FIG. 3, in some examples the pop-up structure 26 of the gift assembly may be moveable between a first position, wherein it is folded substantially flat between the base 16 and the lid 14 (e.g., between the top surface 20 and the bottom surface 32) and a second position, wherein the pop-up structure 26 is unfolded into a three dimensional structure having the token 10 contained upon a pedestal thereof. The design of the pop-up structure 26 may correspond to the token 10 contained thereon. For example, as shown in FIG. 3, if the token 10 provides the gift recipient with a subscription and/or membership to Gamefly, the pop-up structure 26 and/or other portions of the packaging 12 may include text, images, or other content corresponding to and/or associated with Gamefly. Further, if the token 10 provides the gift recipient with a BirchBox subscription, the pop-up structure 26 may contain elements representing makeup, haircare items or other items corresponding to and/or associated with BirchBox. In such examples, the pop-up structure 26 may also contain text, such as “looking good” or other appropriate language not specifically representative of BirchBox, but related to the category or genre (e.g., beauty products) with which the gift is associated. In another example, if the token 10 provides the gift recipient with a Graze subscription, the pop-up structure 26 may contain elements representing various food items or snacks and text such as “yum” or other appropriate content. Each unique gift subscription token 10 may also feature corresponding audio and/or decorative effects which enhance the opening or unwrapping experience. The gift packaging 12 enhances the value proposition by providing meaningful, fun and surprising vehicle for digital gift giving.

In alternate embodiments, the gift packaging 12 may additionally contain a microphone and/or memory for recording and storing a personalized greeting. The gift packaging 12 may also contain various special effects such as at least onelight, and/or various moving parts (via a motor module contained within the gift packaging 12). The packaging 12 may additionally contain various embellishments such as gems, googly eyes, or other such adornments. Additionally, at least one of the sound modules, circuit boards, speakers, power sources, microphones, memory, lights, motors, and/or other components described herein with respect to the packaging 12 associated with the gift assemblies shown in FIGS. 1-3 may also be incorporated into the packaging 12 associated with the gift bundles 300 shown in FIGS. 7 and 8. Likewise, the packaging 12 associated with the gift bundles 300 shown in FIGS. 7 and 8 may also include at least one of the gems, googly eyes, embellishments, and/or other adornments described herein.

In other embodiments, the gift packaging 12 may be provided separately (either included in the cost of the token 10 or available for purchase separately). Such separate packaging 12 may contain a specified pocket, insert, cut-out, vac form, or other special area for receiving a token 10 and the consumer could select a pre-loaded token 10 and separate packaging 12 in which to house and present the token 10 to a recipient.

As noted above, the term “gift packaging” is not intended to include greeting cards. However, in alternate embodiments of the present invention, tokens 10 may be housed inside a greeting card.

While the gift packaging 12 has been described herein as having a circular shape with circular opening, other shapes have been contemplated and are considered to fall within the scope of the present application. Also, while certain materials have been mentioned and certain packaging configurations have been set forth herein, such example embodiments are not meant to limit the present disclosure in any way. Other materials and packaging configuration can be used.

### Purchasing/Activating the Token

An example token 10 of the present disclosure may be purchased from a physical retail store or online from an online retailer. In an example embodiment, a token 10 may contain a unique code or password for providing access to a specific or pre-determined gift item. At a physical retailer, there may exist a “token mall” or area in which various tokens 10 representing various pre-determined gifts are displayed. A consumer may select from the variety of tokens 10 which represent or which provide access to the specific gift which he/she wishes to gift to a recipient. Each token 10 may a unique code printed thereon which is pre-linked to specific gift content.

For example, if the consumer wishes to gift a BirchBox subscription to a gift recipient, then he/she would select the token 10 which corresponds to the BirchBox subscription. As mentioned above, the token 10 itself may contain a pre-printed code which is pre-linked to a BirchBox subscription. The token 10 itself may also have additional printing thereon, such as a company or product logo or other identifying information which identifies the particular gift item represented by the token 10. Alternatively, the content represented and unlocked or redeemed by the token 10 may be identified on the token packaging 12. In an example embodiment, the token 10 is pre-packaged in special gift packaging 12. The tokens 10 may be “live” or “active” prior to the user purchasing said token. Alternatively, the tokens 10 may be activated at the point of sale by, for example scanning a bar code or other scannable code on the token 10 or on the gift packaging. An example code (e.g., a barcode) and/or other information 38 is illustrated in FIG. 2. In some examples, a single code may be used to purchase the token 10 and also activate the token 10. Alternatively, in other examples separate codes may be used to purchase and activate the token 10. Additionally, such codes may be disposed on the token 10 and/or on the packaging 12.

Similarly, a token 10 having a unique code thereon for accessing pre-determined content may be purchased from an online retailer. In this case, the consumer would visit a particular website. The website would display the various tokens 10 containing pre-loaded or pre-determined content or providing access to pre-defined gifts, such as the virtual, electronic or physical content/gifts described above. The user would select the token 10 representing the gift which he/she wishes to gift to a recipient and purchase the token 10 as an online transaction. The consumer may choose to have the token 10 sent directly to him/her so that he/she can personally present it to the recipient or the consumer may choose to have the token 10 sent directly to the recipient by providing the recipient's name and address. Again, the tokens 10 may be “live” or “active” prior to the user purchasing said token 10. Alternatively, the tokens 10 may be activated at the point of sale by, for example scanning a bar code or other scannable code on the token 10 or on the gift packaging 12. A single code may be used to purchase the token 10 and also activate the token 10, or separate codes may be used.

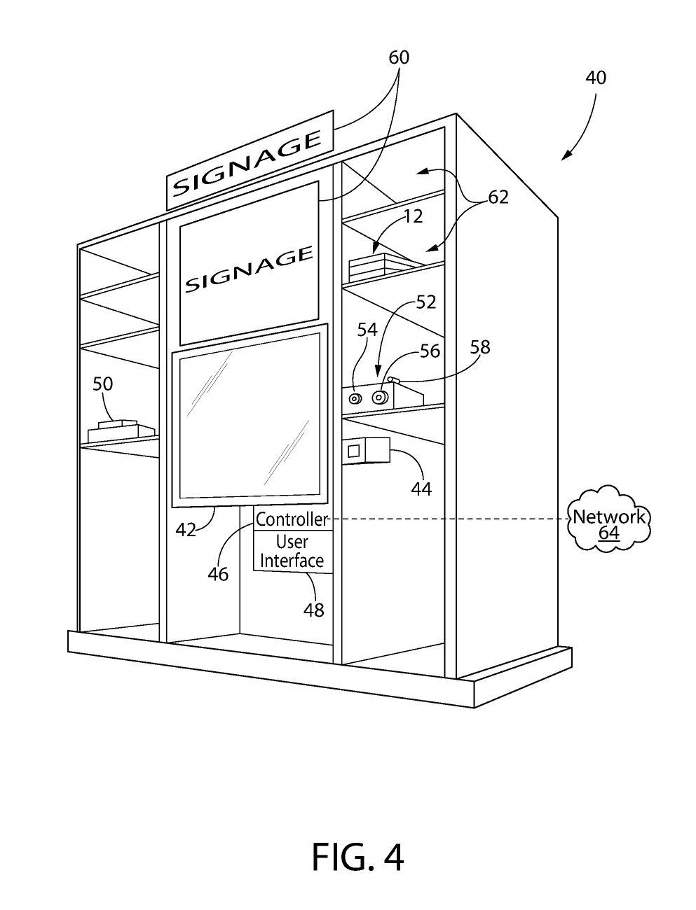

In another embodiment, a blank token 10 can be purchased either in a physical retail store or online. Each blank token 10 may contain artwork or other decorative embellishments. The blank tokens 10 may contain printing thereon which matches or complements selectable gift packaging 12, such as those described above. A blank token 10 may be assigned, loaded or linked with consumer selected content or may be printed, or otherwise indicated with a unique code or password for providing access to a specific gift item. This can be performed at a kiosk (or vending machine) at the point of sale, or via a user's mobile phone or device. Such an example kiosk 40 is illustrated in FIG. 4 and is also described in co-owned U.S. Provisional Patent Application No. 62/400,866, filed Sep. 28, 2016. The entire disclosure of U.S. Provisional Patent Application No. 62/400,866 is incorporated herein by reference.

As shown in FIG. 4, various kiosks 40 of the present disclosure may include one or more walls, a base, and/or a roof, and may define an at least partially enclosed space that enables a purchaser to focus on designing and/or generating a token 10 and/or packaging 12 at a location separate and spaced from a cashier/check-out area of a brick-and-mortar retail environment. Any of the kiosks 40 described herein may enable a purchaser to customize a token 10 and/or packaging 12 associated with the token 10 at a location (e.g., an aisle, and end-cap, a lobby area, a room, etc.) within a brick-and-mortar retail environment. The kiosks 40 of the present disclosure may also be configured to print and/or otherwise generate such tokens 10 and/or packaging 12, and may include any of a variety of components in order to facilitate such functionality. For example, a kiosk 40 may include one or more displays 42, such as a touch screen, an LCD, a touch screen, a smart display, and/or other such device. In such examples, the display 42 may be configured to enable a purchaser to choose a color, content, theme, texture, and/or other aspect of the token 10 and/or the packaging 12. The display 42 may also enable the purchaser to select a third party retail partner with whom the token 10 and the corresponding gift will be associated. The display 42 may also enable the purchaser to load the token 10 with a desired dollar amount and/or with one or more subscriptions or other virtual gifts (e.g., items of value). As a result, such displays 42 may enable the purchaser to select and/or otherwise personalize the value, appearance, content, and other aspects of the token 10 and/or of the packaging 12. In this way, the display 42 may facilitate an interactive and dynamic gift creation exercise that can be enjoyable and even educational for the user.

In some examples, the display 42 may be configured to display and/or otherwise present content to targeted users. For example, the display 42 may enable the supplier of the token 10 and/or of the subscription or other gift associated with a token 10 to present content that is targeted to purchasers. Such content may include advertisements, suggested themes, suggested gift bundles, suggested automation, suggested music, suggested messages, and/or other content that the purchaser may use when designing a unique token 10 and/or packaging 12.

In some examples, the display 42 may comprise a smart display configured to enable the purchaser to scan one or more tokens 10, packaging 12, and/or other items for purchase, activation, configuration (e.g., loading value, content, etc.) and/or other purposes. In other examples, the kiosk 40 may include one or more dedicated scanners 44 configured to enable such functionality. Such scanners 44 may comprise, for example, an RFID scanner, in infrared scanner, a barcode scanner, or other device. Scanning one or more items using the display 42 and/or the scanner 44 of the kiosk 40 may enable the purchaser to, among other things, purchase and/or activate such items at the kiosk 40 (e.g., a purchaser may use a credit card, PayPal, apple pay, or other methods to purchase such items at the kiosk 40), rather than needing to bring such items to a retail outlet cashier. Accordingly, the kiosk 40 and its various components, may enable a customer to assemble, generate, purchase, and/or activate a token 10 (and its associated packaging 12) without interacting with the retail outlet cashier.

In some examples, the consumer may use the scanner 44 to scan a bar code or other scannable code printed on the token 10 and/or on the packaging 12, and a list of content options may appear on the display 42 as a result. Once the consumer has selected content to associate with the token 10, the code from the token 10 may be linked or otherwise associated with the specific token 10 scanned by the consumer. This information may be stored in a remote database (not shown) in communication with the kiosk 40 and/or in communication with a processor or other such controller 46 associated with the kiosk 40. For example, the remote database may be in communication with the controller 46 via one or more networks 64 to which the controller is connected. Such networks 46 may include a wide area network (WAN), a local area network (LAN), the internet, or other data and/or communications networks. Additionally or alternatively, the information described above may be stored in a local memory and/or database associated with the controller 46. The kiosk 40 may also include one or more keyboards, mice, touch pads, and/or other user interfaces 48 in communication with the controller 46 and/or with the smart display 24. Such user interfaces 48 may further assist the user with storing, accessing, and/or manipulating such information, as well as with any of the purchasing, activating, or other activities performed at the kiosk 40.

The kiosk 40 may also include one or more components configured to assist the user in formatting, creating, and/or generating the token 10 and/or the packaging 12. For example, the kiosk user may use the display 42, the controller 46, the user interface 48, and/or other components of the kiosk 40 to create, view, and/or select content to be associated with a token 10. Once the user has selected such content, the user may utilize a printer 50 (e.g., a standard printer ink jet or laser jet printer, or a three-dimensional (3D) printer) of the kiosk 40 to print a bar code or other scannable code which represents the selected content. The user can then take the token 10 and the printed sheet containing the content bar code to a register at a retail outlet in which the kiosk 40 is disposed, and a cashier can scan the token 10 and the the paper with the content bar code to associate the content with the token 10 and to record this relationship in a database. The consumer can then proceed to remit payment for the content. As shown in FIG. 4, the kiosk 40 may also include one or more additional input/output (I/O) devices 52 configured to assist the user in generating such content for inclusion on the packaging 12 and/or for inclusion on the token 10. For example, such I/O devices 52 may include one or more cameras 54 (e.g., a digital camera or other digital imaging device), one or more speakers 56 or other audio output devices, and/or one or more microphones 58 or other audio recording devices. In some examples, one or more of the I/O devices 52 of the kiosk 40 may be combined into a single unit. In other examples, on the other hand, one or more such I/O devices 52 may be a separate and/or stand-alone component of the kiosk 40. Any of the I/O devices 52 may be operably connected to the controller 46, and any of the content generated by the user via such I/O devices 52 may be stored in any of the local or remote databases described above associated with the controller 46.

Further, any of the images, audio messages, video messages, text, or other content generated by the user at the kiosk 40 using such I/O devices 52 and/or using the display 42 or other components of the kiosk 40 may be stored on, printed on, etched on, adhered to, and/or otherwise combined with the token 10 and/or the packaging 12 via the printer 50, one or more memory programming devices (not shown), and/or other components of the kiosk 40. For example, the kiosk 40 may include one or more shelves or other compartments 62 configured to retain substantially blank packaging 12 and/or substantially blank tokens 10. Once the user has generated and/or selected content to be added on the packaging 12 and/or the token 10, the user may insert the packaging 12 and/or the token 10 into the printer 50, one or more memory programming devices, and/or other components of the kiosk 40 configured to format the packaging 12 and/or the token 10. Such components may, for example, print a barcode, QR code, an image, and/or any other content onto the packaging 12 and/or onto the token 10. Additionally or alternatively, such components may store such content (e.g., a video generated by the user at the kiosk 40, an audio greeting generated by the user at the kiosk 40, one or more unique purchase, activation, and/or redemption codes, etc.) on an RFID chip, a memory chip, a magnetic strip, and/or other such storage device of the token 10 and/or of the packaging 12. Such content may be consumed by the recipient of the packaging 12 and/or the token 10 at a later time. In some examples, the kiosk 40 may also include one or more placards, banners, advertisements, or other like signage 60 associated with the tokens 10 and/or packaging 12 described herein. In some examples, such signage 60 may advertise and/or otherwise identify one or more functions of the kiosk 40 in order to pique the interest of the consumer in a crowded retail outlet setting. It is understood that the kiosk 40 illustrated in FIG. 4 and described herein may have any of the components, functionality, and/or other characteristics of the example kiosks described in U.S. Provisional Patent Application No. 62/400,866. Further, in additional embodiments any of the kiosks 40 described herein and/or in U.S. Provisional Patent Application No. 62/400,866 may comprise one or more devices within the purchaser's home or at any other location outside of the brick-and-mortar retail environments described herein. For example, in additional embodiments one or more of the kiosk components described herein (e.g., the display 42, controller 46, user interface 48, printer 50, I/O devices 52 camera 54, speakers 56, and/or other components) may comprise components of a gift assembly device (not shown) disposed, for example, at the home of the purchaser. In such example, any of the gift/content selection, content/token/packaging generation, purchasing, and/or activation activities described herein may be performed using such a gift assembly device and without visiting an example kiosk 40 that is located in a brick-and-mortar retail environment. Such example gift assembly devices may comprise an example electronic communication device of the present disclosure, and such devices may make it easier for purchasers to generate, purchase, and/or activate one or more of the gift assemblies described herein.

In still further examples, various pre-printed tags may be available for selection by the consumer. Each pre-printed tag may represent pre-determined content to be associated with a token 10. In some examples, the consumer may select a blank token 10 and a pre-printed tag, and the two may be linked together at the cash register at the point of sale. As another alternative, the blank token 10 can be assigned content at the point of sale. In such examples, the user may take the blank token 10 to the cash register and the cashier would scan a code on the token 10 or packaging 12 which would then produce a list of content items which can be selected by the consumer and linked to the token 10 at the point of sale. In another embodiment, or as an additional option, a blank token 10 can be assigned content via a user's mobile device. Similarly, the consumer can select and associate a particular blank token 10 with specific content for gifting to a recipient online via a website or via a mobile app. The user may view a website or mobile app containing various token choices. Once a specific token 10 has been selected, the consumer can then view and select specified content to be linked or otherwise associated with the token 10. The information about the token 10 and the content and the link there between can be stored in a database. The user can then pay for the content and either have the token 10 sent to him/her for presentation to the recipient or have the token 10 sent directly to the recipient by providing the recipient's name and address. The gift recipient can authenticate and redeem the token 10 by following one of the methods described in further detail below. In another embodiment, the consumer may select and purchase a blank token 10 at retail and then at a later time select and associate the blank token 10 with specific content via a website or mobile app.

In the embodiments wherein specific consumer-selected content is associated with a blank token 10, options for personalizing this content may be made available to the consumer. For example, the consumer may have the opportunity to add personalized text, add a photo, add a handwritten signature, add audio, add video, or any other consumer-provided content.

In other embodiments, the process for loading a blank token 10 with data or information linking the token 10 to specific content, and/or to specific gifts that may be redeemed using the token 10, may be performed according to the specific components and/or technology printed on or embedded within the token 10. Some examples include a digital watermark, a QR code, an augmented reality marker or other camera-based technology, printed electronics, foil stamping, conductive foam or other conductive technology, gesture and/or motion detection chips or components, facial recognition chips or components, voice recognition chips or components, near field communication chips, such as an RFID tag, and any other current or future technology that can be used to store data. Any such processes can be performed, for example, using the various components of the kiosk 40 as described above. In other examples, any such processes can be performed without the use of the kiosk 40. For example, such processes may be performed by using one or more alternative devices at the retail outlet or at the point of sale. In still other examples, such processes may be performed by the purchaser using one or more electronic communication devices after purchasing the token 10. For instance, the token 10 may include one or more of the gesture and/or motion detection chips or components, facial recognition chips or components, voice recognition chips or components, near field communication chips, and or other devices described herein, and such components may be configured to enable the purchaser to add content to the token 10 and/or to associate one or more corresponding gifts (e.g., a magazine subscription, and/or any of the other gifts described herein) with the token 10 using a hand gesture, a smile, frown, a gaze, and/or other facial expression, a voice command, and/or other like input. Such components may receive one or more such inputs, and/or a combination of such inputs, and may, in response, add corresponding content to the token 10 and/or associate at least one corresponding gift with the token 10. As an example of such a process, the purchaser may provide a voice input, such as “add a one-year subscription to Golf Universe Magazine to this token.” In response to receiving such a voice command, a voice recognition chip of the token 10 may authenticate the input by confirming that the voice input corresponds to the purchaser of the token 10. The voice recognition chip of the token 10 may communicate wirelessly or otherwise with the purchaser's mobile phone, smart TV, or other electronic communication device or database having voice confirmation information stored thereon. Once the voice input has been authenticated, a component of the token 10, such as the voice recognition chip, may communicate with the purchaser's electronic communication device to facilitate adding the desired gift to and/or associating the desired gift with the token 10. In some examples, such components of the token 10 may communicate directly with, for example, a website or database of the provider of such a gift to facilitate adding the desired gift to and/or associating the desired gift with the token 10. In still further examples, one or more of the gesture and/or motion detection chips, facial recognition chips or components, voice recognition chips or components, near field communication chips, and or other devices described herein may be omitted from the token 10 and, instead, such devices may comprise components of the purchaser's mobile phone, smart TV, or other electronic communication device. In such examples, one or more processors, communication devices, RFID chips, NFC components, memory/storage devices, and/or other components of the token 10 may be in communication with the electronic communication device of the purchaser to facilitate adding the desired gift to and/or associating the desired gift with the token 10, but the device of the purchaser may receive the input from the purchaser, may perform one or more of the authentication steps described herein, and/or may communicate with the website or database of the provider of such a gift to facilitate adding the desired gift to and/or associating the desired gift with the token 10.

In another embodiment, the token 10 may be operative to present a gift to a single person from a group of two or more people who each contribute a specific monetary amount (either equal amounts or discretionary amounts) towards the gift content.

In another embodiment, the token 10 may be used in connection with wedding or baby registries wherein a consumer may associate the token 10 with gift content selected from a recipient's wedding or baby registry or alternatively giving the recipient the choice of gifts from his/her registry.

In another embodiment, the token 10 may be used as a charitable gift given on behalf of the token recipient. The recipient may be presented with a list of charitable organizations along with a monetary amount associated with the token 10. The gift recipient can then select the charitable organization to which the monetary amount will be donated.

All of the tokens 10 described above, regardless of the technology printed on or embedded therein, may have a bar code or other scannable code thereon (in addition to other markers, chips or printing) for linking the token 10 (having either pre-linked content or blank) to a specific piece of content and purchasing said token 10.

### Redemption Process

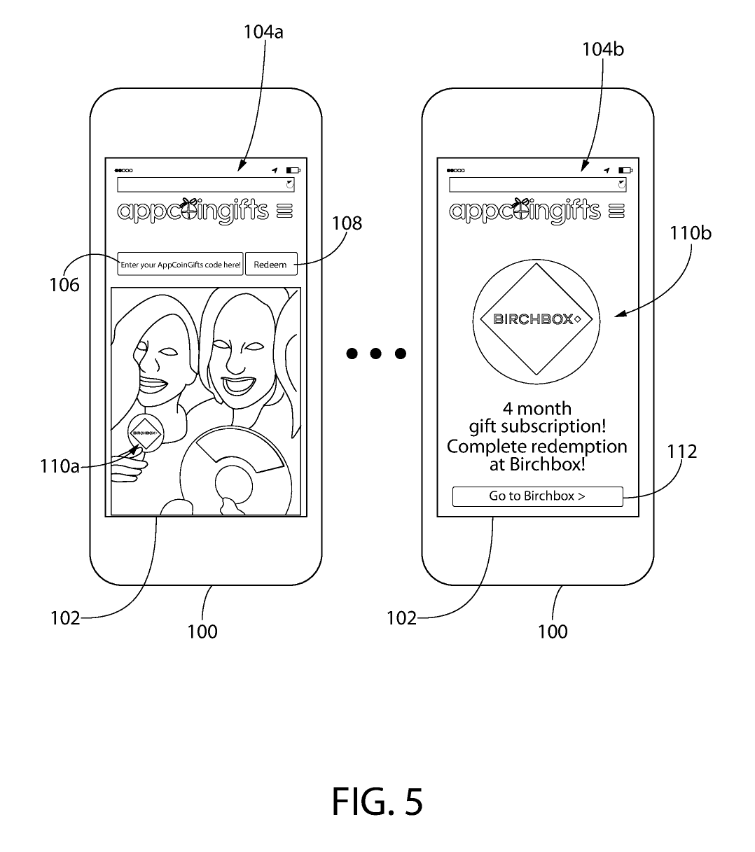

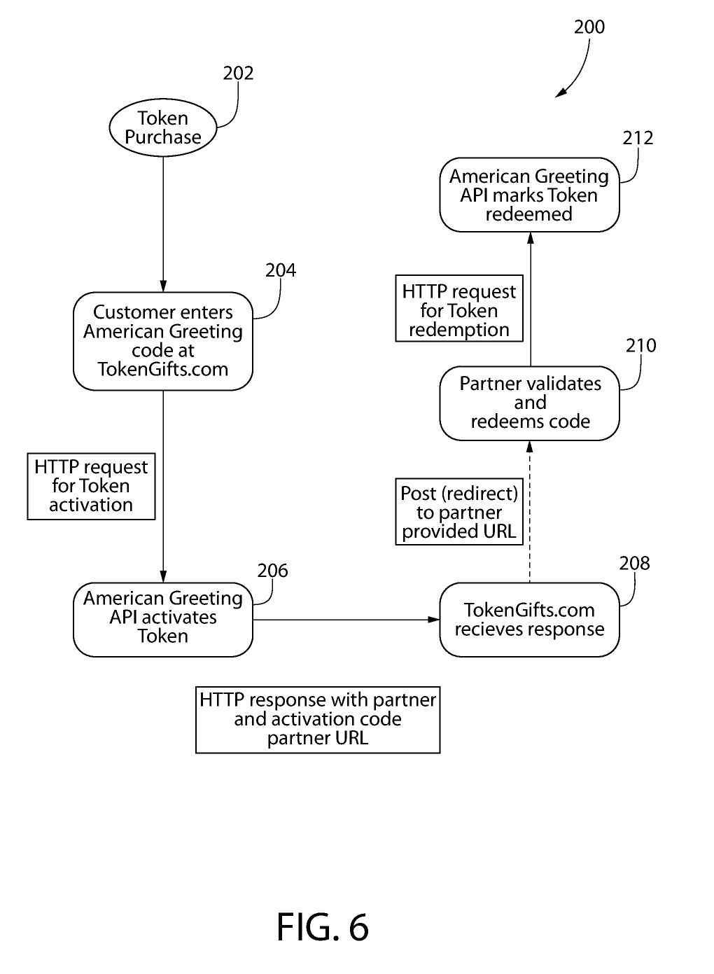

Once a token 10 has been gifted to a recipient, the recipient must redeem the token 10 in order to receive his/her gift. The redemption process includes authentication which determines whether the code contained on the token 10 is a valid code and authorization which provides the user access to the particular content and/or gift linked to the token 10. Various example redemption and/or authentication methods are illustrated by FIGS. 5 and 6.

While various methods were described above with regard to activation or loading content or a code onto the token 10, the methods by which the token 10 is redeemed does not need to be via the same method. For example, a token 10 may include a code which is pre-assigned to a particular gift item. Activating or purchasing that token 10 may involve scanning a bar code (or other scannable code) but redeeming the token 10 may involve scanning a QR code or using NFC or other such technology.

In an example embodiment, the token 10 may contain a unique code or series of characters (alphabetic, numeric or alphanumeric) printed thereon which a user may manually enter onto a specified webpage. The code printed on the token 10 may initially be concealed and require action by the token recipient to reveal the code. The code may be covered by UV Ink (similar to scratch-off lottery tickets or pre-paid cards) or other material which must be scratched off (or otherwise removed) by the token recipient to reveal the code printed therebeneath. The code may alternatively be concealed by a pull-tab or other user-removable material or by may be hidden beneath a portion of the packaging 12. Once the code printed on the token 10 is revealed (if it is initially concealed), the user may go to a specific website by entering a specified uniform resource locator (URL) into an internet browser. The URL may be printed directly onto the token 10 or it may be contained on an insert which is packaged with the token 10 or it may be contained on a portion of the packaging 12. Once the token recipient has reached the website indicated by the URL, the recipient may view a welcome experience and obtain additional information regarding the token 10, the method for redeeming said token 10, and other facts about the token 10 or the redemption process. The recipient may then enter the unique code printed on the token 10 on an area of the website indicated for accepting gift token codes. The website receives the code and verifies that the code is authentic, a process which is described in further detail below. If the code is deemed authentic, the website may 1.) require the user to login or to setup a user login and password, or 2.) direct the user to a third party website wherein the user is required to login or to setup a user login and password. Once the user has successfully logged in, the gift item is confirmed and the user can continue redeeming the gift, based on the type of gift. For example, if the gift is a subscription-based physical gift, the user may be required to enter his/her name and delivery address and may be asked for additional information. If the gift is a subscription-based digital gift, the user will be required to enter his/her name, email address and phone number and may be asked to provide additional information and to download an app which provides the user access to or which facilitates the user's use of the gift.

In another embodiment, similar to the embodiment described directly above, the token 10 may contain a code printed thereon (either concealed or unconcealed) which the user may use to enter into a mobile app. Instructions for downloading the mobile app may be printed on the token 10, on an insert packaged with the token 10, or on the packaging 12. For example, the mobile app may be accessed for download from the Apple App Store, Google Play marketplace, Chrome web store, or any other online marketplace. An example mobile app that is active on a mobile device 100 is illustrated in FIG. 5. Applicant notes that the illustrations included in FIG. 5, and the corresponding descriptions presented herein, are merely exemplary of one or more portions, functions, and/or components of an example mobile app associated with the gift assemblies of the present disclosure. In additional embodiments, example mobile apps configured to assist in purchasing, activating, and/or redeeming one or more tokens 10 of the present disclosure may have configurations not illustrated in FIG. 5. Further in such examples, one or more portions controls, user interfaces, and/or other parts of the mobile app illustrated in FIG. 5 may be omitted. For instance, in another example embodiment the mobile app may enable the recipient of a gift assembly to activate the token 10 and/or redeem a gift associated with the token 10 by directing the recipient directly to the partner and/or other entity providing the redeemed gift (e.g., Birchbox, Gamefly, etc.). In such examples, one or more of the controls and/or user interfaces illustrated in FIG. 5 may be omitted from the mobile app.

As shown in FIG. 5, a display 102 of the mobile device 100 may display, present, and/or otherwise provide one or more user interfaces 104a, 104b . . . 104n (referred to collectively herein as “user interfaces 104”) to assist the user in redeeming and/or authenticating the token 10. For example, the user interfaces 104 may include one or more data entry fields 106 configured to receive the unique code printed on the token 10 and/or on the associated packaging 12. The user interfaces 104 may also include one or more buttons or other like controls 108, 112 configured to receive one or more touch inputs or other inputs from the user of the mobile device 100. The user interfaces 104 may further include one or more portions 110a, 110b . . . 110n (referred to collectively herein as “portions 110”) in which content may be displayed to the user. Such content may include, for example, advertisements, instructions, or information related to the token 10 or gift being redeemed. Once the mobile app is downloaded to the token recipient's mobile device 100 and opened, the token recipient may enter the code printed on the token 10 into one or more of the data entry fields 106 provided by the user interfaces 104. The mobile app may transfer the received code to one or more remote servers or other devices in communication with the mobile device 100, and one or more such devices may verify that the received code is authentic. If the code is authentic, then the mobile app may either direct the token recipient to a third party website via the mobile device 100 wherein the recipient may be asked to login or to create a user name and password. After the recipient has successfully logged in, the gift is confirmed. The user may be asked to enter further information, depending on the type of gift received.

In another embodiment, the token 10 may contain a digital watermark, a QR code, an augmented reality marker or other camera or scan-based technology printed on or embedded within the token 10. In this case, the token recipient may use his/her mobile device 100 to either scan or take a picture of the scan-based technology printed on the token 10. The information retrieved by scanning may be a Uniform Resource Locator (URL) and a unique code which specifically identifies the token 10. The URL directs the user's mobile device 100 to a specific website wherein the unique redemption code can be entered via one or more data entry fields 106 configured to receive the unique code. The mobile app may transfer the received code to one or more remote servers or other devices in communication with the mobile device 100, and one or more such devices may verify that the received code is authentic. If successful, the mobile app may redeem or “unlock” the token 10 thereby providing the gift recipient access to the gifted content.

In another embodiment, the token 10 may contain printed electronics, foil stamping, conductive foam, or other conductive technology printed on or embedded within the token 10 which would enable the token 10 to communicate with a multi-touch surface of a touchscreen device, such as the mobile device 100. Most touch screen devices use a capacitive touch screen wherein a circuit is completed by the touch of a finger. The token 10 may contain a conductive thread which, when in contact with the display 102 of the device 100, will imitate a finger touch, tap or swipe. This allows the token 10 to initiate or trigger some action by the mobile device 100. The user may be directed to a particular website or directed to download a specific mobile app. Once the user has reached the website or mobile app, placing the token 10 on the touchscreen or other display 102 of the mobile device 100 “unlocks” the token 10 by initiating the authentication and redemption processes which, if successful, provide the gift recipient access to the gifted content.

In another embodiment, the token 10 may contain an augmented reality marker. To redeem such a token 10, a gesture, voice, or motion detection is recognized by a website or downloaded mobile or computer app when viewed through a camera or webcam of the mobile device 100. In this embodiment, the user would reach the indicated website or download and open a specific mobile app which would prompt the user to aim the camera at the token 10 and complete a specific gesture or motion-based action. For example, the user may be asked to wave the token 10 back and forth, or hold it next to their face and smile, or hold the token 10 in their right hand while jumping up and down. Completing the specified action would “unlock” the token 10 by initiating the authentication and redemption processes which, if successful, provide the gift recipient access to the gifted content. As noted above, similar gesture recognition, voice recognition, facial recognition, and/or other processes may be used by the purchaser of the token 10 to a desired gift to and/or associate a desired gift with the token 10.

In another embodiment, the token 10 may contain an RFID chip (or other NFC technology). To redeem such a token 10, the user may be instructed to download an app to his/her mobile device 100, and such a mobile device 100 may include an NFC reader. With the app open, placing the token 10 on or near the mobile device 100 may “unlock” or otherwise provide the gift recipient with access to the gifted content. Example methods and devices associated with activating and redeeming an example token 10 using RFID and/or NFC technology are described in co-owned U.S. Provisional Patent Application No. 62/403,600, filed Oct. 3, 2016, the entire disclosure of which is incorporated herein by reference. In such example methods, the customary barcodes, UFC codes or other codes described above may be replaced by the RFID chip embedded within, disposed on, and/or otherwise connected to one or more gift items. For instance, in such examples the RFID chip need not be accessible at retail when purchasing and/or activating the item containing the RFID chip. As a result, fraud may be minimized. Additionally, while one or more RFID chips may be disposed in or on any of the tokens 10 described herein, in further examples such RFID chips may be disposed in, disposed on, and/or otherwise connected to any other item (e.g., a gift card, a box, a coffee mug, a doll, a vase, a candle, etc.) capable of being gifted by the purchaser. In an example embodiment, one or more such items containing an RFID chip may be pre-wrapped inside of a box or other packaging 12. The RFID chip may be configured to emit a unique frequency assigned as a unique identifier associated with the item and/or the gift to be redeemed. In such examples, the purchaser may bring the pre-wrapped item to the cashier at a retail outlet, and the cashier may “scan” the pre-wrapped gift using an RFID scanner at the point-of-sale terminal. In response, the RFID scanner may recognize and/or otherwise “read” the frequency being emitted by the RFID chip from within the packaging. The RFID scanner and/or one or processors to which it is connected may then send a signal to a remote activation service which may then activate the item. In such embodiments, the customer may purchase the pre-wrapped item via the cashier at the retail outlet, and the sale price tendered by the customer may be equal to the total cost of the pre-packaged item and the value of the subscription or other amount stored in or on the RFID chip.

Alternatively, in another example embodiment a customer may purchase the pre-wrapped item via the cashier at the retail outlet, and the sale price tendered by the customer may be equal to the total cost of the pre-packaged item only. In such examples, after purchasing the pre-wrapped item the customer may “scan” the pre-wrapped item (post-sale) using an RFID scanner, a NFC reader, and/or other device on the customer's mobile device 100. In response, the components of the customer's mobile device 100 may recognize and/or otherwise “read” the frequency being emitted by the RFID chip from within the packaging. The RFID scanner, NFC reader, and/or other device on the customer's mobile device 100 may then assign a monetary value to the frequency and/or to the RFID chip using, for example, a wallet app, a credit card, paypal, apple pay, and/or other payment methods linked to the mobile device 100. In some examples, an app that is active on the mobile device 100 may receive the NFC signal from the RFID chip and may facilitate sending payment to one or more entities (e.g., the retail outlet, a third party activation service, etc.) associated with the sale, authentication, and/or activation of the item. Such an example app may also send a signal to the third party activation service requesting activation of the gift card, token 10, or other item associated with the RFID chip. Further, once a recipient receives the pre-wrapped item from the customer, the recipient may open the package and remove the gift card, token 10, or other item from the packaging. Using an RFID scanner, a NFC reader, and/or other device on the recipient's mobile device 100, the recipient may redeem the item by using a wallet app, or other app of their choice. For example, a value carried by the item associated with the activated RFID may be transferred to the recipient's wallet app and may be spent by the recipient online or in a brick and mortar retail outlet.

In still another embodiment, the token 10 or packaging 12 may, in combination with a downloaded app (mobile or non-mobile), initiate an automated reveal and redemption process.

For example, opening the packaging 12 to reveal a token 10 can trigger automated playback of an audio sound, audio clip or audio signal which triggers the app to initiate the gift reveal and redemption process without further user interaction.

### Authentication/Authorization/Redemption Process

In each of the above-referenced redemption processes, the token 10 must be authenticated to determine that the code contained on or linked to the token 10 is a valid code. Once the token 10 is deemed valid, the user is authorized to access the gifted content. An example process associated with authenticating, authorizing, and/or redeeming a token 10 is further illustrated by the flow chart 200 shown in FIG. 6.

In an example embodiment, a customer may purchase one or more tokens 10 and/or associated packaging 12 at step: 202. Such a purchase may occur in an online environment or at a brick-and-mortar retail outlet. As noted above, in some examples a cashier at the retail outlet may add monetary value and/or any of the other gifts described herein to the token 10 at the point of purchase. Alternatively, the customer may add value and/or any of the other gifts described herein to the token 10 using his/her mobile device 100 or other electronic communication device after the sale transaction has taken place. In any of the examples described herein, the token 10 and/or the packaging 12 may include a unique code printed thereon which is linked to a specific gift subscription or other such gift. Additionally, in any of the examples described herein, such a unique code may be linked to and/or may uniquely identify the particular retail outlet at which the token 10 and/or the packaging 12 was purchased. Such unique codes may also (or alternatively) identify the retailer, generally. In such examples, if the token 10 is a “blank” token 10 (e.g., a token that does not include monetary value and/or any of the other gifts described herein linked thereto when the token 10 is purchased), the purchaser may add and/or associate one or more such gifts with the token 10 after purchasing the token 10 via any of the processes described above. As part of this process, the purchaser may be instructed (e.g., by instruction on the token 10, on the packaging 12, and/or included in a particular system website used by the purchaser to add and/or associate the gift with the blank token 10) to enter the unique code described above into a data field on the particular website. In examples in which the unique code identifies the particular retail outlet at which the token 10 and/or the packaging was purchased, the system may be configured to direct a percentage of the cost of the gift and/or any other percentage/share of revenue associated with the purchase of such a gift back to the identified retail outlet (or to the retailer, generally). Accordingly, in such examples, the unique codes described herein may assist in attributing proceeds of the sale of one or more gifts associated with the token 10 back to the retailer at which the token 10 and/or the packaging 12 was purchased.

As noted above, in any of the examples described herein, instructions on the token 10 or on the packaging 12 may instruct the customer to visit a particular system website. After purchasing the token 10 and/or the packaging 12, the customer may visit the website identified in such instructions and, at step: 204 the customer may enter the unique code into an area specified on the system website. For example, the customer may visit a website dedicated to token activation/redemption at step: 204 (e.g., www.TokenGifts.com) and may enter the unique code in one or more data entry fields included in a user interface of the website. Alternatively, at step: 204 the customer may activate an app dedicated to token activation/redemption on his/her mobile device 100 at step: 204, and may enter the unique code in one or more data entry fields 106 included in a user interface 104 of the app. At step: 204 the mobile app or the website may generate a hypertext transfer protocol (HTTP) request for activating the token 10 associated with the unique code, and may send the request to a server, processor, and/or other remote system device with which the website and/or the mobile app is operably connected. In such examples, the mobile app or the website may send the HTTP request to an application programming interface (API) associated with the remote system device for activation of the token 10.

At step: 206, the remote system device may activate the token 10 in response to receiving the request. For example, in response to receiving the HTTP request described above, the API of the remote system device may search a system database to determine if the unique code entered at step: 204 is a valid code. If the code is found in the system database, API and/or other component of the remote system device may send the code, along with a URL to a specific website of a partner/content provider (e.g., the entity providing the gift associated with the token 10) to the website or the mobile app. The mobile app or the website may receive such an API response from the remote system device at step: 208. At least partly in response to receiving such a response, the mobile app or the website may redirect the gift recipient to the URL contained in the API response. Once the partner/content provider website is reached, the partner/content provider may redeem the token 10 at step: 210, thereby providing the gift recipient access to the gifted content. In such examples, the partner/content provider website (e.g., an API associated with the website) may send an HTTP request back to the API associated with the remote system device to indicate that the code has been redeemed. At step: 212, the API associated with the remote system device may mark the code as redeemed in the system database at least partly in response to receiving such an HTTP request.

In other embodiments, the specific technology used with the token 10 may dictate how the token 10 is redeemed. For example, as described above, a token 10 having a digital watermark printed thereon may require the user to scan the digital watermark on the token 10 which may then direct the recipient to a website or may open a downloaded app on a mobile device 100 where the above-described redemption process is executed. Additionally, the steps included in FIG. 6, and the corresponding descriptions presented herein, are merely exemplary of purchase, activation and/or redemption method associated with the gift assemblies of the present disclosure. In additional embodiments, example purchase, activation, and/or redemption methods of the present disclosure may include steps and/or other components or functionality not illustrated in FIG. 6. Further in such examples, one or more steps illustrated in FIG. 6 may be omitted.

### System Hardware/Software

As described above, a system for the token redemption process to authenticate the code and authorized the content may include, but is not limited to a communications network, cloud services, servers, databases, software, a web browser, electronic communication devices, a mobile app, and an Application Programming Interface (API).

Unless otherwise defined, all technical terms used herein have the same meaning as commonly understood by one having ordinary skill in the art to which this invention applies. The examples set forth herein are intended to describe particular embodiments only and are not intended to limit the invention in any way.

The term “network” as used herein includes, but is not limited to: a collection of hardware components and computer or machines interconnected by communications channels that allow sharing of resources and information, including, without limitation, the worldwide web or the internet.

The term “server” as used herein, includes, but is not limited to: a computer or machine (physical or virtual) or a device on a network that manages network resources. The general term “server” may include specific types of servers such as an application server (a computer which executes specific logic in software/computer programs), a file server (a computer and storage device dedicated to storing files), a print server (a computer that manages one or more printers), a network server (a computer than manages network traffic), and a database server (a computer system that processes database queries). Although servers are frequently dedicated to performing only server tasks, certain multiprocessing operating systems allow a server to manage other non-server related resources. A “web server” as used herein, includes, but is not limited to: a server which serves content to a web browser by lading a file from a disk and serving it across a network to a user's web browser, typically using a HTTP.

The term “cloud services” as used herein means services made available on demand via the internet from a cloud computing provider's servers as opposed to being provided from a company's own servers.

The term “software” or “computer program” as used herein includes, but is not limited to: one or more computer or machine readable and/or executable instructions that cause a computer, microprocessor, logic circuit, or other electronic device to perform functions, actions and/or behave in a desired manner. The instructions may be embodied in various forms such as routines, algorithms, modules or programs including separate applications or code from dynamically linked libraries. Software may also be implemented in various forms such as stand-alone programs, apps, a function call, a servlet, an applet, instructions stored in a memory or any other computer readable medium, part of an operating system of other type of executable instructions. It will be appreciated by one of ordinary skill in the art that the form of software is dependent on, for example, requirements of a desired application, the environment it runs on, and/or the desires of a designer/programmer or the like.

The term “web browser” as used herein, includes, but is not limited to: a software for retrieving and presenting information resources on the worldwide web. An information resource may be a web page, an image, a video, or any other type of electronic content.

“Electronic Communication Devices”, as used herein, includes, but is not limited to a phone (e.g., a mobile phone), a smartphone, a tablet, a personal data assistant (PDA), a notebook, a personal computer, a laptop computer, a smart TV, a handheld or console-based game system, a digital media receiver (e.g. Apple TV, Roku), a smart digital video disc (DVD) player, a smart device (e.g., Alexa by Amazon, Google Home, and/or other devices in communication via and/or associated with the internet of things), and wearable devices (e.g., smart watch). Any of the processes described herein may be performed by one or more such electronic communication devices. In particular, any of the selection, generation, purchasing, activation, redemption, and or other processes described herein may be performed by one or more such electronic communication devices even if such processes are described herein only with respect to, for example, a mobile phone, a kiosk 40, and or other devices.

“Mobile application” or “Mobile App” or “App” as used herein, includes, but is not limited to: applications that run on mobile phones, tablet computers and other mobile devices. The terms “mobile application”, “mobile app” and “app” can be used synonymously with “software”. Mobile applications allow users to connect to services which are traditionally available on a desktop or notebook platforms. Typically, these services access the internet or intranet or cellular or wireless fidelity networks to access, retrieve, transmit and share data.

The terms “computer”, “processor” or “processing unit” as used herein, includes, but is not limited to: any programmed or programmable electronic device, microprocessor, logic unit that can store, retrieve and process data.

“API files” or “API” or “Application Programming Interface” as used herein, includes, but is not limited to: an interface between different software programs or software files which facilitate the interaction of the different software programs or software files by way of a specific set of rules and specifications.

“Electronic Greeting Card”, “e-greeting”, “e-greeting card” or “e-card”, as used herein, includes, but is not limited to any greeting card, or a personalized message or a message which delivers a pieces of communication from one user to another user or non-user through electronic media.

The foregoing embodiments and clauses of the present disclosure have been presented for the purposes of illustration and description. These descriptions and embodiments are not intended to be exhaustive or to limit the disclosure to the precise form disclosed, and obviously many modifications and variations are possible in light of the above disclosure. The embodiments were chosen and described in order to best explain the principle of the disclosure and its practical application to thereby enable others skilled in the art to best utilize the invention in its various embodiments and with various modifications as are suited to the particular use contemplated.

1. A gift assembly, comprising:
packaging including
a base having a top surface and a bottom surface opposite the top surface,
a lid moveable relative to the base between a first position in which a bottom surface of the lid extends substantially parallel to the top surface of the base, and a second position in which the bottom surface of the lid extends at an included angle relative to the top surface of the base, and
a pop-up structure disposed between the top surface of the base and the bottom surface of the lid, the pop-up structure being configured such that movement of the lid causes commensurate movement of the pop-up structure; and
a token removably retained by the pop-up structure, at least one of the token or the packaging including a unique identifier operative to provide access to a digital gift.

2. The gift assembly of claim 1, wherein the pop-up structure is at least partially connected to at least one of the lid and the base, the pop-up structure including a substantially planar surface.

3. The gift assembly of claim 2, wherein the substantially planar surface of the pop-up structure extends along at least part of at least one of the top surface of the base and the bottom surface of the lid when the lid is disposed in the first position.

4. The gift assembly of claim 2, wherein the substantially planar surface of the pop-up structure is spaced from and extends substantially parallel to the top surface of the base when the lid is disposed in the second position.

5. The gift assembly of claim 2, wherein the substantially planar surface of the pop-up structure comprises one of a top surface of the pop-up structure or a bottom surface of the pop-up structure opposite the top surface of the pop-up structure.

6. The gift assembly of claim 1, wherein at least part of the token is disposed within or on one of a shelf, a recess, a channel, and a cavity of the pop-up structure when the lid is disposed in the first position.

7. The gift assembly of claim 1, wherein the pop-up structure includes at least one of an adhesive, a clip, a latch, and Velcro® configured to temporarily retain the token.

8. The gift assembly of claim 1, wherein the lid includes
an opening through which the token is visible, and
a layer of substantially transparent material covering the opening, the layer being configured to assist in retaining the token within the packaging while the lid is in the first position.

9. The gift assembly of claim 1, wherein the at least one of the token or the packaging includes an RFID chip, and the unique identifier comprises a unique frequency emitted by the RFID chip.

10. The gift assembly of claim 1, wherein the unique identifier comprises a code disposed on the token, and wherein the packaging blocks access to the code when the lid is in the first position.

11. A gift assembly, comprising:
packaging including
a base having a top surface and a bottom surface opposite the top surface,
a lid moveable relative to the base to provide access to an inner compartment of the packaging,
a first retention component disposed within the inner compartment, and
a second retention component separate from the first retention component disposed within the inner compartment;
a token removably retained by the first retention component within the inner compartment, at least one of the token or the packaging including a unique identifier operative to provide access to a digital gift associated with the token; and
an additional gift item associated with a theme corresponding to the token, the additional gift item being physically separate from the token and removably retained by the second retention component within the inner compartment.

12. The gift assembly of claim 11, the packaging further comprising at least one sidewall, wherein the inner compartment is formed, at least in part, by the base, the lid, and the at least one sidewall, the token and the additional gift being substantially surrounded by the at least one sidewall.

13. The gift assembly of claim 12, wherein the at least one sidewall extends substantially perpendicularly from at least one of the base and the lid.

14. The gift assembly of claim 11, wherein:
at least part of the token is disposed within or on one of a shelf, a recess, a channel, and a cavity of the first retention component; and
the second retention component includes at least one of a clip, a tie, a latch, and a clamp.

15. The gift assembly of claim 11, further comprising a third retention component disposed within the inner compartment, and an additional token retained by the third retention component within the inner compartment, the additional token including an additional unique identifier operative to provide access to an additional digital gift corresponding to the additional token, wherein the additional digital gift is associated with the theme.

16. The gift assembly of claim 11, wherein at least one of the token and the additional gift item comprises a gift card having a component storing an amount of monetary value.

17. The gift assembly of claim 11, wherein the packaging further includes at least one of a sound module, a speaker, a light, and a motor.

18. A kiosk, comprising:
one or more walls;
a controller at least partially supported by the one or more walls and operably connected to a network; and
a display connected to the controller and configured to assist a user in generating a token, the token including a unique identifier operative to provide access to a digital gift,
wherein the controller is configured to enable the user to, using the network, at least one of purchase and activate the token at the kiosk.

19. The kiosk of claim 18, wherein the kiosk comprises at least two opposing sidewalls, a base, and a roof, the at least two opposing sidewalls, the base, and the roof defining at least part of a substantially enclosed space of the kiosk separate from a check-out area of a brick-and-mortar retailer.

20. The kiosk of claim 18, wherein the component of the kiosk comprises one of the display and a scanner separate from the display.

21. The kiosk of claim 18, further comprising at least one of a camera, a speaker, and a microphone configured to assist the user in generating content for inclusion on at least one of the token and packaging configured to removably retain the token.

22. The kiosk of claim 18, further comprising a printer configured to print the unique identifier on the token, the printer being further configured to print additional content selected by the user on at least one of the token and packaging configured to removably retain the token.

23. A token, comprising:
a top surface;
a bottom surface opposite the top surface;
a unique identifier disposed on one of the top surface and the bottom surface, the unique identifier being operative to provide access to a digital gift separate from the token; and
visual indicia disposed on at least one of the top surface and the bottom surface, the visual indicia being indicative of the digital gift.
